(19) United States
(12) Patent Application Publication
(10) Pub. No.: US 2014/0012800 A1
(43) Pub. Date: Jan. 9, 2014

(54) APPARATUS AND METHOD FOR PROVIDING APPLICATION FOR PROCESSING BIG DATA

(71) Applicant: Electronics And Telecommuncations Research Institute, Daejeon (KR)

(72) Inventors: Byeong-Thaek OH, Daejeon (KR); Kyoung-Hyun PARK, Daejeon (KR); Hee-Sun WON, Daejeon (KR); Sung-Jin HUR, Daejeon (KR)

(21) Appl. No.: 13/933,871

(22) Filed: Jul. 2, 2013

(30) Foreign Application Priority Data
Jul. 4, 2012 (KR) 10-2012-0072742

(51) Int. Cl. G06F 17/30

(52) U.S. Cl. CPC G06F 17/30592
USPC 707/603

(57) ABSTRACT

Disclosed herein are an apparatus and method for providing an application for processing big data. The apparatus includes a setting unit, a unified information access unit, a metadata management unit, and a database unit. The setting unit sets data collection and analytic levels and a result screen for each of a plurality of tenants. The unified information access unit collects data based on the settings of the setting unit, and analyzes the collected data. The metadata management unit manages metadata about the data collected based on the settings of the setting unit. The database unit stores the collected data and the analyzed data.

### CROSS REFERENCE TO RELATED APPLICATION

This application claims the benefit of Korean Patent Application No. 10-2012-0072742, filed on Jul. 4, 2012, which is hereby incorporated by reference in its entirety into this application.

### BACKGROUND OF THE INVENTION

1. Technical Field

The present invention relates generally to the provision of an application and, more particularly, to an apparatus and method for providing an application for processing big data via an online service over the Internet.

2. Description of the Related Art

In general, applications are provided using an Application Service Provider (ASP) over the Internet. Generally, an ASP refers to a method of providing a service in such a way that an application user can use an online application by paying a specific amount of money on a monthly basis or leasing the online application for a set period of use. The ASP market is expected to significantly grow because of the facts that an Information Technology (IT) infrastructure expands through the expansion of dedicated lines, and online applications can be used inexpensively by users.

Meanwhile, with regard to the conventional technologies, the direct installation model and the ASP model for providing an online application online mostly provide groupware and Customer Relationship Management (CRM) and Enterprise Resource Planning (ERP) solutions on a one-to-one basis. That is, a single application should be executed for a single organization that will use the application, and also a large number of elements should be customized for the organization upon installation, thereby making installation costs high and management work, such as changes in settings, difficult to handle.

Furthermore, an instance of the application should be individually executed and managed, and a related database should be provided on a one-to-one basis, so it is difficult to take advantage of the economy of scale.

Furthermore, recently, as the importance of the analysis of data related to Social Network Services (SNSs) and social media continuously increases, the number of companies which need to collect and analyze big data in order to manage customers or promote products becomes larger.

However, in order to collect and analyze big data, tens or hundreds of servers are required, and the introduction of a viable solution requires large expenses, so it is very difficult to introduce such a system.

While Korean Patent No. 1064634 discloses a user-customized content provision method and system for providing user-customized content to each user when the user orders desired content, the method and system provide an application customized for each user, so the method and system have a limitation with regard to the reduction in the expenses that are incurred to purchase and manage an application and hardware.

### SUMMARY OF THE INVENTION

Accordingly, the present invention has been made keeping in mind the above problems occurring in the prior art, and an object of the present invention is to provide an application that collects and analyzes big data, including structured data and unstructured data, and provides a customized online service to each of a plurality of tenants.

Another object of the present invention is to provide an application, customized for a tenant to which a user belongs, over the Internet, rather than to install and use an application in a user terminal.

In order to accomplish the above objects, the present invention provides an apparatus for providing an application for processing big data, including a setting unit configured to set data collection and analytic levels and a result screen for each of a plurality of tenants; a unified information access unit configured to collect data based on the settings of the setting unit, and to analyze the collected data; a metadata management unit configured to manage metadata about the data collected based on the settings of the setting unit; and a database unit configured to store the collected data and the analyzed data.

The apparatus may further include a screen presentation unit configured to provide the analyzed data to the tenant based on the result screen set for the tenant in response to a request from the tenant.

The setting unit may set different collection and analytic levels for each of data inside the tenant and data outside the tenant for the tenant, and may set different collection and analytic levels for each of structured data and unstructured data for the tenant.

The unified information access unit may collect and analyze data inside the tenant and data outside the tenant for the tenant while distinguishing between them, and may collect and analyze structured data and unstructured data while distinguishing between them.

The metadata management unit may store information about the collection and analytic levels, analysis elements and the analysis result screen, set for data for the tenant, as metadata, and may present a screen for the tenant using the metadata when access for the tenant is made later.

The database unit may store the collected data and the analyzed data while classifying them into structured data and unstructured data.

In order to accomplish the above objects, the present invention provides a method of providing an application for processing big data, including setting data collection and analytic levels and a result screen for each of a plurality of tenants; collecting data based on the settings made as a result of the setting, and analyzing the collected data; and storing the collected data and the analyzed data.

The method may further include, before the collecting data and analyzing the collected data, setting data which is selected from the data inside the tenant and which will be opened to the outside; and assigning a weight to each website or social media.

The method may further include, before the collecting data and analyzing the collected data, setting an object for analysis of activity logs of a user inside or outside the tenant; and setting preprocessing for data mining.

The method may further include providing the analyzed data to the tenant based on the result screen set for the tenant in response to a request from the tenant.

The setting data collection and analytic levels and a result screen for each of a plurality of tenants may include setting different collection and analytic levels for each of data inside the tenant and data outside the tenant for the tenant and setting different collection and analytic levels for each of structured data and unstructured data for the tenant.

The setting data collection and analytic levels and a result screen for each of a plurality of tenants may include storing information about the collection and analytic levels, analysis elements and the analysis result screen, set for data for the tenant, as metadata.

The collecting data based on the settings made as a result of the setting and analyzing of the collected data may include collecting the data using the metadata and analyzing the collected data.

The collecting data based on the settings made as a result of the setting and analyzing of the collected data may include collecting and analyzing data inside the tenant and data outside the tenant for the tenant while distinguishing between them and collecting and analyzing structured data and unstructured data while distinguishing between them.

The storing the collected data and the analyzed data may include storing the collected data and the analyzed data while classifying them into structured data and unstructured data.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram illustrating the operation of an apparatus for providing an application according to an embodiment of the present invention;

FIG. 2 is a block diagram showing the configuration of the apparatus for providing an application according to the embodiment of the present invention;

FIG. 3 is a flowchart showing the setting of a big data analysis service which is provided by the apparatus for providing an application according to the embodiment of the present invention; and

FIG. 4 is a flowchart showing the analysis of big data which is provided by the apparatus for providing an application according to the embodiment of the present invention.

### DESCRIPTION OF THE PREFERRED EMBODIMENTS

The present invention will be described in detail below with reference to the accompanying drawings. Repeated descriptions and descriptions of known functions and constructions which have been deemed to make the gist of the present invention unnecessarily vague will be omitted below. The embodiments of the present invention are provided in order to fully describe the present invention to a person having ordinary knowledge in the art. Accordingly, the shapes, sizes, etc. of elements in the drawings may be exaggerated to make the description clear.

Embodiments of the present invention will be described in detail with reference to the accompanying drawings.

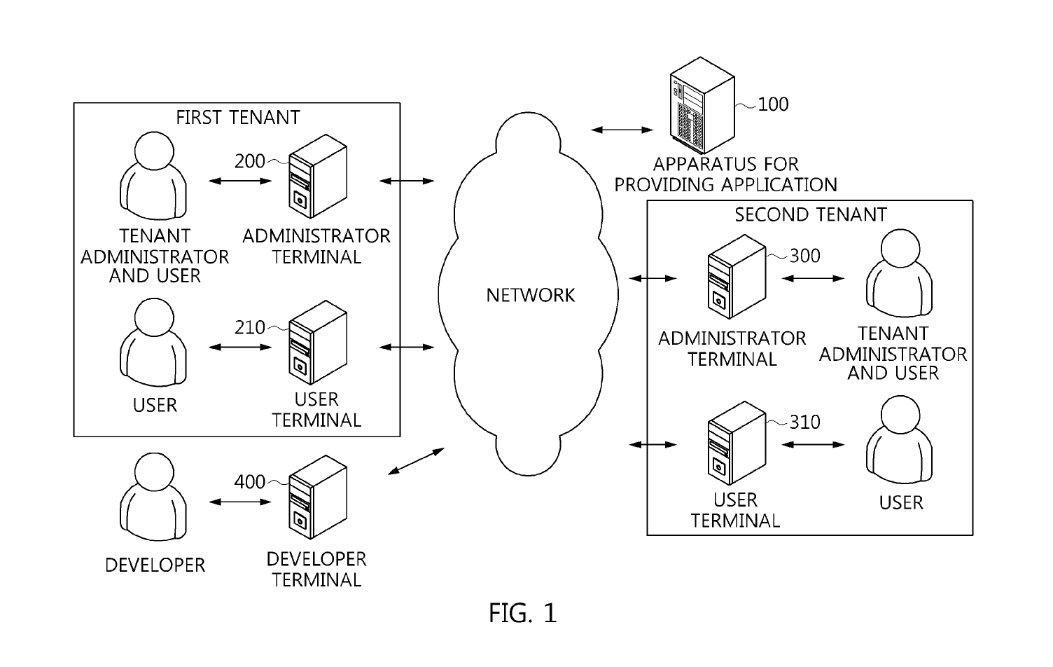

FIG. 1 is a conceptual diagram illustrating the operation of an apparatus for providing an application according to an embodiment of the present invention.

Referring to FIG. 1, in order to illustrate the provision of an application for processing big data according to an embodiment of the present invention, an apparatus 100 for providing an application, administrator terminals 200 and 300 and user terminals 210 and 310 included in a plurality of tenants, and an application developer terminal 400 are shown. These devices may be connected over a network or the Internet.

As shown in FIG. 1, the plurality of tenants may be present. For example, a first tenant and a second tenant may be present, and each of the tenants may include the administrator terminal 200 or 300 operated by an administrator and the user terminal 210 or 310 operated by a user.

The apparatus 100 for providing an application sets the online application environment of the tenant in response to a request from the administrator of the tenant. The apparatus 100 for providing an application may provide an online application, customized according to the set online application environment, to the administrator terminal 200 or 300 and the user terminal 210 or 310 which belong to the corresponding tenant.

Here, the term “tenant” refers to a user group to which the terminals 200 and 210, or 300 and 310 and users using the terminals belong, and may be a company, an organization, or an association. That is, the tenant is a user group to which the terminals 200 and 210, or 300 and 310 which use similar applications and the users who use the terminals 200 and 210, or 300 and 310. In this case, the tenant may include an administrator and a user who use the administrator terminal 200 or 300 and the user terminal 210 or 310.

The administrator terminal 200 or 300 of each tenant may set and manage the online application use environment of the tenant. That is, the administrator terminal 200 or 300 enables the administrator of each tenant to customize the apparatus 100 for providing an application for the tenant and to make settings. Here, the administrator terminals 200 and 300 may also perform the user terminal function of using an application based on an application use environment.

The user terminals 210 and 310 access the apparatus 100 for providing an application over a network or the Internet, and use online applications based on the application use environments that were set by the administrator terminals 200 and 300 so that they are suitable for the respective tenants.

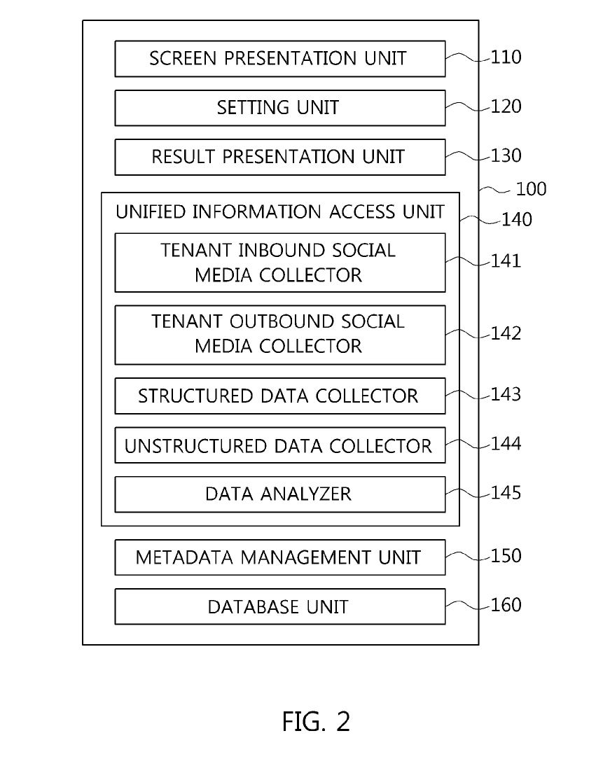

FIG. 2 is a block diagram showing the configuration of the apparatus 100 for providing an application according to the embodiment of the present invention.

Referring to FIG. 2, the apparatus 100 for providing an application according to the embodiment of the present invention includes a screen presentation unit 110, a setting unit 120, a result presentation unit 130, a unified information access unit 140, a metadata management unit 150, and a database unit 160.

While the screen presentation unit 110, the setting unit 120, the result presentation unit 130, the unified information access unit 140, the metadata management unit 150, and the database unit 160 will be described as separate elements in the following description of the present invention, the screen presentation unit 110, the setting unit 120, the result presentation unit 130, the unified information access unit 140, the metadata management unit 150 and the database unit 160 may be implemented in a single form, as a single physical device, or as a single module. Furthermore, the screen presentation unit 110, the setting unit 120, the result presentation unit 130, the unified information access unit 140, the metadata management unit 150 and the database unit 160 may be implemented as a plurality of physical devices or groups, rather than a single physical device or group.

The apparatus 100 for providing an application collects and analyzes structured and unstructured data for each tenant, obtains the results of the analysis, and provides the results of the analysis to the user terminals 210 and 310.

The screen presentation unit 110 may obtain the results of the analysis of the unified information access unit 140 (which will be described later) via the metadata management unit 150 and the result presentation unit 130, and present a set result screen for each tenant.

The administrator for each tenant data may set a collection level, an analytic level and a screen for the tenant via the administrator setting unit 120 using the terminal 200 or 300. The setting unit 120 may set a collection level and an analytic level for data. That is, the setting unit 120 may set different collection and analytic levels for data inside the tenant and data outside the tenant, and may set different collection and analytic levels for structured data and unstructured data.

The result presentation unit 130 may process the results of the analysis of data obtained by the integrated information collection unit 140 based on the settings of the setting unit 120.

The unified information access unit 140 may collect data and analyze collected data based on the settings of the setting unit 120. That is, the unified information access unit 140 may include a platform for Unified Information Access (UIA). The unified information access unit 140 may collect and analyze data inside the tenant and data outside the tenant while distinguishing between them. Here, the data may include data related to social media. Furthermore, the unified information access unit 140 may collect and analyze structured data and unstructured data while distinguishing between them. Accordingly, the unified information access unit 140 may collect data inside the tenant and data outside the tenant while distinguishing between them, and may collect and analyze structured data and unstructured data while distinguishing between them.

For example, the unified information access unit 140 may include a tenant inbound social media collector 141 configured to collect data related to data related to social media which are used by users inside the tenant and a tenant outbound social media collector 142 configured to collect data related to social media outside the tenant. Furthermore, the unified information access unit 140 may include a structured data collector 143 configured to collect structured data and an unstructured data collector 144 configured to collect unstructured data. Furthermore, the unified information access unit 140 may include a data analyzer 145 configured to analyze collected information.

The metadata management unit 150 may store information about data collection and analytic levels, analysis elements and an analysis result screen, set for each tenant, as metadata. Later, when access for each tenant is made, a screen for each tenant is presented using the information stored as the metadata.

The database unit 160 may store collected data while distinguishing between the data. Furthermore, the database unit 160 may store the results of the analysis of the unified information access unit 140 while distinguishing between the results. For example, the database unit 160 may store data inside each tenant and data outside the tenant while distinguishing between them, and may store structured data and unstructured data while distinguishing between them.

Accordingly, according to the embodiment of the present invention, in the provision of an application for processing big data, there is provided the apparatus for providing an application, including the setting unit configured to set a data collection level, a analytic level and a result screen for each tenant, the unified information access unit configured to collect data and analyze collected data based on the settings of the setting unit, and the database unit configured to store the collected data and the analyzed data.

Furthermore, the apparatus for providing an application may further include the screen presentation unit 110 configured to provide analyzed data to a corresponding tenant based on the result screen set for each tenant in response to a request from the tenant.

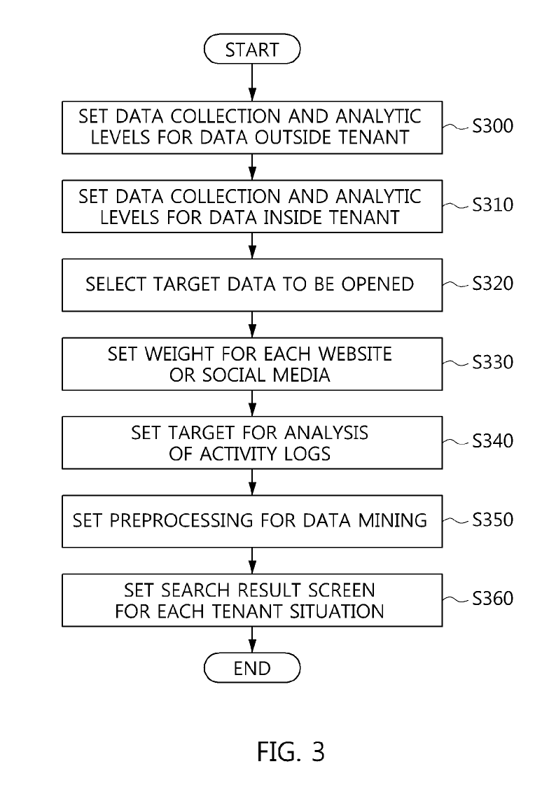

FIG. 3 is a flowchart showing the setting of a big data analysis service which is provided by the apparatus for providing an application according to the embodiment of the present invention.

Referring to FIG. 3, the administrator of each tenant may set a data collection level, an analytic level and a screen for the tenant via the setting unit 120.

A method of providing an application according to an embodiment of the present invention may be implemented as a plurality of physical devices or groups, rather than a single physical device or group. Each of the steps that are included in the method of providing an application according to the embodiment of the present invention may be implemented as a single physical device, a single module or a single piece of software.

First, data collection and analytic levels are set for websites and social media outside each tenant at step S300, and then data collection and analytic levels are set for websites and social media inside the tenant at step S310.

When data collection and analytic levels are set for websites and social media outside and inside the tenant, different collection and analytic levels may be set for structured data and unstructured data.

Furthermore, in order to promote the tenant or form a positive image of the tenant, target data which is selected from data inside the tenant and which will be opened to the outside during searching may be set at step S320. Furthermore, in order to obtain search results suitable for the tenant, a weight may be set for each website or social media at step S330.

Furthermore, a target may be set for the analysis of the activity logs of a user inside or outside the tenant at step S340, and settings may be made for preprocessing for data mining at step S350.

Furthermore, in the method of providing an application for processing big data according to the embodiment of the present invention, information about a result screen may be set such that the results of the analysis of the data collected for each tenant can be provided in response to the situation of the tenant at step S360.

Accordingly, the method of providing an application for processing big data according to the embodiment of the present invention includes the step of setting a data collection level, an analytic level and a result screen for each tenant, the step of collecting data and analyzing collected data based on the stetting of the setting step, and the step of storing the collected data and the analyzed data.

Furthermore, the method may further include the step of providing the analyzed data to the tenant based on the result screen set for the tenant in response to a request from the tenant.

In particular, when a data collection level, an analytic level and a screen are set for each tenant, it may be possible to set different data collection and analytic levels for data inside the tenant and data outside the tenant, and data which is selected from data inside the tenant and which will be opened to the outside may be set.

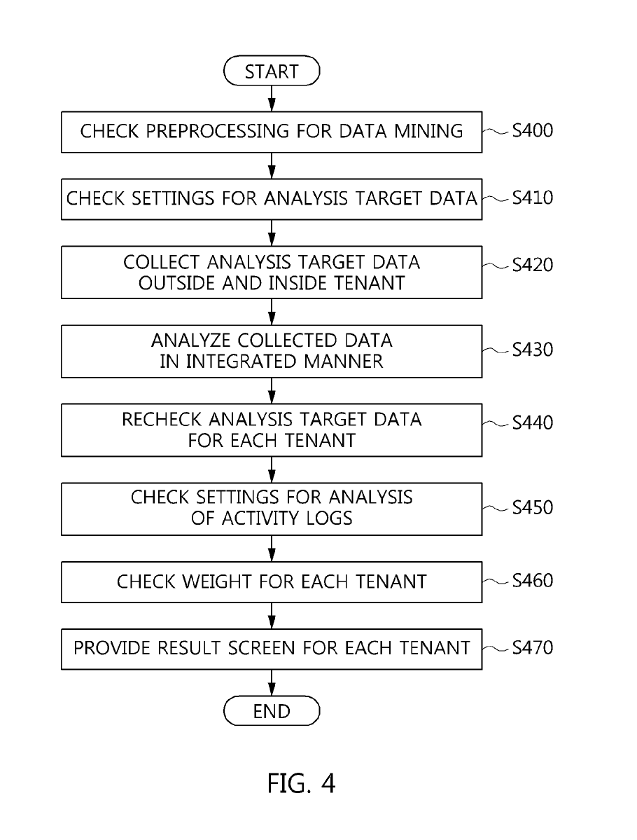

FIG. 4 is a flowchart showing the analysis of big data which is provided by the apparatus for providing an application according to the embodiment of the present invention.

Referring to FIG. 4, there is illustrated a method by which the administrator of each tenant collects and analyzes data and presents the results of the analysis based on the setting made via the setting unit 120.

First, information about preprocessing for data mining may be checked at step S400. Thereafter, the details of settings for collection and analytic levels for websites and social media inside and outside each tenant and the details of settings for collection and analytic levels for structured data and unstructured data may be checked at step S410.

Thereafter, it may be possible to collect data related to websites and social media inside and outside the tenant while classifying it into structured data and unstructured data at step S420. The collected data is collectively analyzed by the apparatus 100 for providing an application regardless of the tenant at step S430, and analysis target data for the tenant is checked to present the results of analysis for the tenant at step S440.

Furthermore, the details of settings for the analysis of the log activities of a user inside or outside the tenant may be checked at step S450, and a weight set for each tenant and for each website or social media may be checked at step S460. Furthermore, the results of the analysis may be processed for each tenant based on the settings made via the setting unit 120 and provided via a screen at step S470.

In particular, when collecting and analyzing data, it may be possible to collect and analyze data inside the tenant and data outside the tenant while distinguishing between them and to collect and analyze structured data and unstructured data while distinguishing between them.

The above-described apparatus and method for providing an application according to the present invention can collect and analyze big data, including structured data and unstructured data, and can provide an online service customized for each of a plurality of tenants.

Furthermore, the above-described apparatus and method for providing an application according to the present invention can convert results output from the single unified information access unit into a service customized for each tenant and then provide the resulting results by sharing the single unified information access unit for collecting and analyzing big data and using a technology for handling metadata about settings and analysis results. This enables tenants, each represented as users or a user group, to be supported using a single application instance.

Furthermore, the above-described apparatus and method for providing an application according to the present invention provides a service customized for each tenant by supporting a plurality of tenants using a single application instance. This can prevent high expenses from being incurred to achieve customization, and enables expenses to be reduced by supporting service in such a way as to execute a single application instance for a plurality of tenants rather than to execute application instances for respective tenants.

Moreover, the above-described apparatus and method for providing an application according to the present invention provides an application, customized for a tenant to which a user belongs, over the Internet, rather than to install and use an application in a user terminal, thereby minimizing the expenses that are incurred when purchasing and managing the application and hardware.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for providing an application for processing big data, comprising:
a setting unit configured to set data collection and analytic levels and a result screen for each of a plurality of tenants;
a unified information access unit configured to collect data based on the settings of the setting unit, and to analyze the collected data;
a metadata management unit configured to manage metadata about the data collected based on the settings of the setting unit; and
a database unit configured to store the collected data and the analyzed data.

2. The apparatus of claim 1, further comprising a screen presentation unit configured to provide the analyzed data to the tenant based on the result screen set for the tenant in response to a request from the tenant.

3. The apparatus of claim 1, wherein the setting unit sets different collection and analytic levels for each of data inside the tenant and data outside the tenant for the tenant and sets different collection and analytic levels for each of structured data and unstructured data for the tenant.

4. The apparatus of claim 1, wherein the unified information access unit collects and analyzes data inside the tenant and data outside the tenant for the tenant while distinguishing between them, and collects and analyzes structured data and unstructured data while distinguishing between them.

5. The apparatus of claim 1, wherein the metadata management unit stores information about the collection and analytic levels, analysis elements and the analysis result screen, set for data for the tenant, as metadata, and presents a screen for the tenant using the metadata when access for the tenant is made later.

6. The apparatus of claim 1, wherein the database unit stores the collected data and the analyzed data while classifying them into structured data and unstructured data.

7. A method of providing an application for processing big data, comprising:
setting data collection and analytic levels and a result screen for each of a plurality of tenants;
collecting data based on the settings made as a result of the setting, and analyzing the collected data; and
storing the collected data and the analyzed data.

8. The method of claim 7, further comprising, before the collecting data and analyzing the collected data:
setting data which is selected from the data inside the tenant and which will be opened to the outside; and
assigning a weight to each website or social media.

9. The method of claim 7, further comprising, before the collecting data and analyzing the collected data:
setting an object for analysis of activity logs of a user inside or outside the tenant; and
setting preprocessing for data mining.

10. The method of claim 7, further comprising providing the analyzed data to the tenant based on the result screen set for the tenant in response to a request from the tenant.

11. The method of claim 7, wherein the setting data collection and analytic levels and a result screen for each of a plurality of tenants comprises setting different collection and analytic levels for each of data inside the tenant and data outside the tenant for the tenant and setting different collection and analytic levels for each of structured data and unstructured data for the tenant.

12. The method of claim 7, wherein the setting data collection and analytic levels and a result screen for each of a plurality of tenants comprises storing information about the collection and analytic levels, analysis elements and the analysis result screen, set for data for the tenant, as metadata.

13. The method of claim 12, wherein the collecting data based on the settings made as a result of the setting and analyzing of the collected data comprises collecting the data using the metadata and analyzing the collected data.

14. The method of claim 7, wherein the collecting data based on the settings made as a result of the setting and analyzing of the collected data comprises collecting and analyzing data inside the tenant and data outside the tenant for the tenant while distinguishing between them, and collecting and analyzing structured data and unstructured data while distinguishing between them.

15. The method of claim 7, wherein the storing the collected data and the analyzed data comprises storing the collected data and the analyzed data while classifying them into structured data and unstructured data.
